(19) United States
(12) Patent Application Publication
(10) Pub. No.: US 2002/0090482 A1
(43) Pub. Date: Jul. 11, 2002

(54) Release sheet with printed layer, pressure sensitive adhesive label having the printed layer, and method of manufacturing the pressure sensitive adhesive label using thermal transfer printing

(75) Inventor: Seiya Motomiya, Sakado-Shi (JP)

Correspondence Address: BRINKS HOFER GILSON & LIONE, P.O. BOX 10395, CHICAGO, IL, 60610, US

(73) Assignee: LINTEC CORPORATION

(21) Appl. No.: 10/037,587

(22) Filed: Oct. 23, 2001

(30) Foreign Application Priority Data
Oct. 24, 2000 (JP) 2000-324604

(51) Int. Cl. B32B 9/00

(52) U.S. Cl. 428/41.6; 156/289; 428/41.8

(57) ABSTRACT

Disclosed is a release sheet with a printed layer for use with a pressure sensitive adhesive label for indicating information. The release sheet comprises a release sheet base, a releasing agent layer provided on one of the surfaces of the release sheet base, and a printed layer provided on the releasing agent layer. The printed layer has fixed and/or variable information and is formed by means of thermal transfer printing. Further, a pressure sensitive adhesive label for indicating information is also disclosed. The pressure sensitive adhesive label is adapted to be stuck onto the release sheet with the printed layer mentioned above before the pressure sensitive adhesive label is used.

### BACKGROUND OF THE IVENTION

1. Field of the Invention

This invention relates to a release sheet with printed layer, a pressure sensitive adhesive label having the printed layer, and a method of manufacturing the pressure sensitive adhesive label using thermal transfer printing. More specifically, this invention relates to a release sheet with a printed layer formed by means of thermal transfer printing, a pressure sensitive adhesive label with the printed layer for indicating information of the printed layer, and a method of manufacturing the pressure sensitive adhesive label with the printed layer using thermal transfer printing. The pressure sensitive adhesive label with the printed layer according to the present invention is preferably used as so-called security labels. In this specification, the term “pressure sensitive adhesive label” means a pressure sensitive adhesive sheet for indicating information, which has a predetermined shape and is comprised of a label base and a pressure sensitive adhesive layer provided on one surface of the label base. The pressure sensitive adhesive label is being attached to a release sheet through the pressure sensitive adhesive layer thereof before the use thereof.

2. Description of the Prior Art

Various types of pressure sensitive adhesive labels on which letters, designs, pictures and the like (hereinafter, simply referred to as “information”) are indicated are widely used for many purposes. In most of these labels, such information is indicated on top surfaces of the labels (that is, outer surfaces of the label bases). Further, there are also known other types of pressure sensitive adhesive labels in which such information is indicated on the back surfaces of the labels.

Normally, the latter labels are manufactured by directly printing the information on the surfaces of the pressure-sensitive adhesive layers. However, this manufacturing method causes the case that the pressure sensitive adhesive used in the pressure sensitive adhesive layer adheres on a printing head of a printing apparatus.

In order to avoid such a case, there is an approach that, after printing information on the back surface of the label base of the pressure sensitive adhesive label, a pressure sensitive adhesive layer is formed on the back surface of the label base so as to cover the information. However, this method requires to perform a step for printing the information during the manufacturing process of the pressure sensitive adhesive label, so that a manufacturing apparatus necessarily becomes large, and therefore this method is not suited for manufacturing pressure sensitive adhesive labels of a small lot.

Further, Japanese Laid-open Patent Application No. 6-175586 discloses other method in which information is printed on a release sheet and then such a release sheet is stuck onto a pressure sensitive adhesive layer of a pressure sensitive adhesive label so that the printed information is transferred to the pressure sensitive adhesive layer. However, this method requires to prepare in advance various printing forms for printing various information, so that this method needs many equipments and a lot of troubles and therefore is not suited for printing variable information such as serial numbers or date.

Meanwhile, besides the pressure sensitive adhesive labels described above, there is known a seal having a pressure-sensitive adhesive layer containing a fluorescent dye. According to this type of seal, a part of an adherend to which the seal was being stuck is luminescent by irradiation of an ultraviolet ray or the like after the seal has been removed from the adherend. In this type of seal, there is a demand that the luminescent part of the adherend can indicate any information.

### SUMMARY OF THE INVENTION

Accordingly, it is an object of the present invention to provide a release sheet with a printed layer for use with a pressure sensitive adhesive label which can easily form printed information on the pressure sensitive adhesive label with a relatively simple manufacturing equipment.

It is another object of the present invention to provide a pressure sensitive adhesive label which can be easily provided with printed information.

It is other object of the present invention to provide a method of manufacturing such a pressure sensitive adhesive label provided with the printed information.

In order to achieve these objects, the present invention is directed to a release sheet with a printed layer for use with a pressure sensitive adhesive label for indicating information. The release sheet with a printed layer comprises a release sheet base; a releasing agent layer provided on one of the surfaces of the release sheet base; and a printed layer provided on the releasing agent layer, said printed layer having fixed and/or variable information and being formed by means of thermal transfer printing.

Another aspect of the present invention is directed to a pressure sensitive adhesive label for indicating information. The pressure sensitive adhesive label being adapted to be stuck onto a release sheet with a printed layer before the pressure sensitive adhesive label is used, which comprises a label base; a pressure sensitive adhesive layer provided on one of the surfaces of the label base; and a printed layer provided on the pressure sensitive adhesive layer, said printed layer having fixed and/or variable information, wherein the release sheet according to claim 1 is stuck onto the pressure sensitive adhesive layer through the releasing agent layer so that the printing layer faces the pressure sensitive adhesive layer.

In this case, it is also preferred that the pressure sensitive adhesive layer contains fluorescent dye and the printed layer includes a metallic layer.

Yet another aspect of the present invention is directed to a method of manufacturing a pressure sensitive adhesive label with a printed layer for indicating information. The method comprises the steps of: preparing a release sheet having a release sheet base and a releasing agent layer provided on one surface of the release sheet base, and then forming a printed layer having fixed and/or variable information on the releasing agent layer by means of thermal transfer printing, thereby forming a release sheet with a printed layer; preparing a pressure sensitive adhesive label having a label base and a pressure sensitive adhesive layer provided on one surface of the label base; sticking the pressure sensitive adhesive layer of the pressure sensitive adhesive label onto the releasing agent layer of the release sheet such that the printed layer faces the pressure sensitive adhesive layer; and transferring the pressure sensitive adhesive layer from the printed layer on the release agent layer.

In this method, it is preferred that the pressure sensitive adhesive layer contains fluorescent dye and the printing layer includes a metallic layer.

These and other objects structures and advantages of the present invention will be apparent from the following detailed description of the invention and the examples taken in conjunction with the appended drawings.

### BRIEF DESCRIPTION OF THE DRAWING

FIGS. 1(a) to (c) are cross-sectional views for explaining the manufacturing process of the pressure sensitive adhesive label with the printed layer according to the present invention.

FIG. 2 is a cross-sectional view for explaining the structure of a thermal transfer printing ribbon for use in a second embodiment of the release sheet with the printed layer according to the present invention.

FIG. 3 is a cross-sectional view the release sheet with the printed layer according to the second embodiment.

### DETAILED DESCRIPTION OF THE PREFERRED EMBODIMENTS

Hereinbelow, a detailed description of the preferred embodiments of the present invention will be described with reference to the drawing

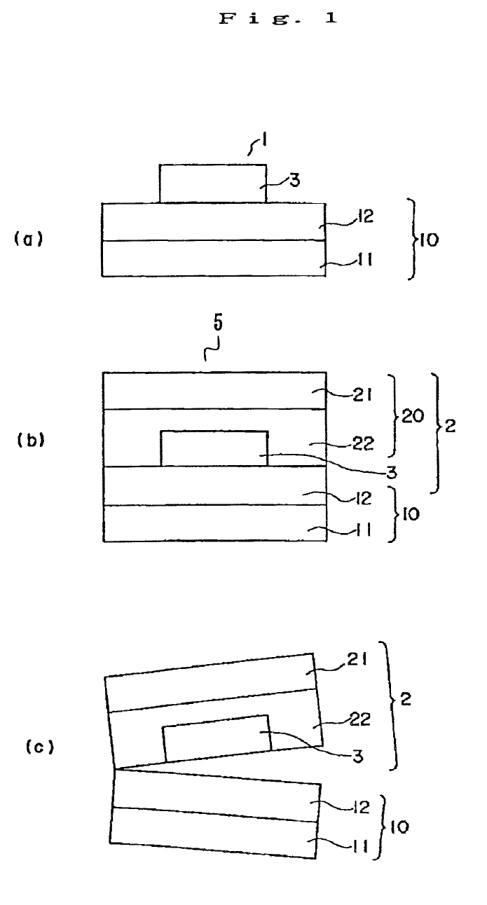

In FIGS. 1(a), (b) and (c) the reference numeral 1 denotes a release sheet with a printed layer, 2 denotes a pressure sensitive adhesive label with a printed layer and 3 denotes a printed layer. The release sheet with the printed layer 1 is composed of a release sheet 10 and the printed layer 3 provided on one surface thereof. Further, the pressure sensitive adhesive label with the printed layer 2 is composed of a pressure sensitive adhesive label 20 and the printed layer 3 transferred from the release sheet with the printed layer 1. Furthermore, the pressure sensitive adhesive label with the release sheet having the printed layer 5 includes the release sheet with the printed layer 1 and the pressure sensitive adhesive label 20 attached to the surface of the release sheet 10 on which the printed layer 3 is provided.

Specifically, the release sheet with the printed layer 1 of the present invention is adapted to be used with the pressure sensitive adhesive label 20 for indicating information. In more detail, the release sheet with the printed layer 1 is generally constructed from a release sheet 10 composed of a release sheet base 11 having opposite surfaces and a releasing agent layer 12 provided on one of the surfaces of the release sheet base 11. Further, a printed layer 3 is provided on the releasing agent layer 12 to form the release sheet with the printed layer 1. The printed layer 3 has fixed or variable information, and it is formed on the releasing agent layer 12 by means of thermal transfer printing.

Thus constructed release sheet with the printed layer 1 is adapted to be stuck onto a pressure sensitive adhesive layer 22 of the pressure sensitive adhesive label 20. Namely, the release sheet with the printed layer 1 is stuck onto the pressure sensitive adhesive layer 22 through the releasing agent layer 12 of the release sheet 1 such that the printed layer 3 faces the pressure sensitive adhesive layer 22 of the adhesive label 20. When the pressure sensitive adhesive label 20 is released (peeled off) from the release sheet 10, the printed layer 3 is transferred to the pressure sensitive adhesive layer 22, so that the pressure sensitive adhesive label with the printed layer 2 is obtained.

The release sheet base 11 of the release sheet 10 has a function to support the releasing agent layer 12, and it is constituted from, for example, a plastic film such as polyester film (e.g. polyethylene terephthalate film and polybutylene terephthalate film), polyolefin film (e.g. polypropylene film and polymethylpentene film), and polycarbonate film and the like; a metal foil such as aluminum foil and stainless steel foil; a paper such as glassine paper, woodfree paper, coated paper, impregnated paper such as dust free paper and drafting paper, and synthetic paper; or a laminate body of two or more of those materials.

The thickness of the release sheet base 11 is not particularly limited to a specific value, but normally it is in the range of 20 to 200 μm, and preferably in the range of 25 to 100 μm.

On at least one surface of the release sheet base 11, there is provided a releasing agent layer 12 which is constituted of a releasing agent.

Examples of the releasing agent which can be used for the releasing agent layer 12 include a silicone based releasing agent and a non-silicone based releasing agent.

Examples of the silicone based releasing agent include an addition type silicone which is obtained by addition-reacting organo polysiloxane containing aliphatic unsaturated base with organo hydrogen polysiloxane using a catalyst of a platinum based compound, and a condensing type silicone obtained by condensing-reacting organo polysiloxane using an organic acid type metallic salts catalyst such as an organic tin compound. These silicone compositions can be used in a solution state in which the composition is resolved into an organic solution such as toluene or the like, in an emulsion state which is obtained by emulsifying the solution, or in a non-solution state consisting of the silicone alone.

Examples of the non-silicone based releasing agent which can be used for the releasing agent layer 12 include polyolefins such as polyethylene, thermoplastic elastomers such as olefin-based thermoplastic elastomers, fluororesins such as tetrafluoroethylene, waxes, alkyd resins, and mixture of two or more of them.

Among these releasing agents, the non-silicone based releasing agent is particularly preferred for the releasing agent used in the releasing agent layer 12 of the release sheet 10 of the present invention, since use of such a releasing agent makes it easy to obtain appropriate adhesion with the printed layer 3 and appropriate releasability from the pressure sensitive adhesive label 2. Further, it is also preferred that the releasing agent contains both olefin-based thermoplastic elastomer and polyethylene.

In this regard, it is to be understood that the releasing agent layer 12 may contain other resin components and/or various additives such as plasticizer or stabilizer.

The thickness of the releasing agent layer 12 is not particularly limited to a specific value, but it is preferable that the thickness is in the range of 0.1 to 50 μm, and it is more preferable that the thickness is in the range of 0.3 to 30 μm. If the thickness of the releasing agent layer 12 is less than 0.1 μm, the releasability becomes poor. Further, in the case where the thickness exceeds 50 μm, it is also impossible to improve the releasability. In addition, provision of such a thick releasing agent layer is not economical since too much releasing agent is needed.

As described above, on the surface of the releasing agent layer 12 of the release sheet 10 of the present invention, there is provided the printed layer 3 for indicating various information including fixed (constant) information and/or variable information, and such a printed layer 3 is formed by thermal transfer printing. Here, the fixed information means information common to all the labels. Examples of the fixed information include a frame design, a company name, a product name and the like. Further, the variable information means information which must be changed in each of the labels or in each set of the labels. Example of such variable information include a serial number, a production data and the like.

By forming such a printed layer 3 on the release sheet 10 by means of the thermal transfer printing, it becomes possible to retain the printing layer 3 on the surface of the releasing agent layer 12 reliably so that the printed layer 3 can be properly transferred to the pressure sensitive adhesive layer 22 of the pressure sensitive adhesive label 20 when the pressure sensitive adhesive label 20 is removed from the release sheet 10 in a state that the pressure sensitive adhesive label 20 has been stuck onto the release sheet with the printed layer 1. Further, it also becomes possible to provide pressure sensitive adhesive labels with the printed layers 2 which can indicate not only fixed information but also variable information with a simple manufacturing process.

Further, since such a printed layer 3 can be formed using a thermal transfer printer, it is not necessary to prepare any large size equipment. In this case, the printed layer 3 can be formed using a commercially available thermal transfer printing ribbon (not shown in the drawing).

The transfer layer of the thermal transfer printing ribbon may be either of a single layer type comprised of a thermo-melting (hot melt) resin containing a vehicle such as pigment or dye or a multi-layer type composed of a metallic layer and a thermo-melting (hot melt) resin layer.

The thermo-melting resin is not particularly limited, but examples of the thermo-melting resin include olefin based copolymer resins such as ethylene-vinylacetate copolymer, ethylene-acrylic ester copolymer, polyamide based resins, polyester based resins, epoxy based resins, polyurethane based resins, acrylic based resins, vinyl chloride based resins, cellulose based resins, vinyl alcohol based resins, fatty acid ester based resins, phenol based resins, styrene based resins, vinylacetate based resins, and thermo-melting elastomers such as natural rubber, styrene-butadiene rubber, isoprene rubber, and chloroprene rubber, and the like.

Further, known wax such as paraffin wax, ethylene wax and stearic acid may be added as needed.

Examples of the metal that can be used in the metallic layer include gold, silver and aluminum, for example. Such a metallic layer can be formed by means of deposition or spattering.

The adhesive strength between the printed layer 3 and the releasing agent layer 12 is not particularly limited if the printed layer 3 is not peeled off or fallen off from the releasing agent layer 12 before the pressure sensitive adhesive label 20 is stuck thereto after the formation of the printed layer 3 and the adhesive strength is equal to or less than the releasing force required when the pressure sensitive adhesive label 20 is released from the release sheet 10.

Next, a description will be made with regard to the pressure sensitive adhesive label 20 for use with the release sheet with the printed layer 1 described above. As for the pressure sensitive adhesive label 20, it is possible to use a conventional pressure sensitive adhesive label which is comprised of a label base 21 and a pressure sensitive adhesive layer 22 provided on one surface of the label base 21.

The label base 21 has a function to support the pressure sensitive adhesive layer 22, and it may be formed from the same material as that for the release sheet base 11. Further, the label base 21 may be formed into a single layer structure or a multi layer structure.

If the label base 21 is formed of a transparent material, the label base 21 can act as a protecting layer for the printed layer 3. In this case, the information indicated by the printed layer 3 can be seen through the label base 21.

On the other hand, if the label base 21 is formed of a non-transparent material, it is possible to obtain a pressure sensitive adhesive label with a printed layer 2 which is to be attached to a transparent adherend so that the information indicated by the printed layer 3 is seen from the inside of the adherend. Further, the pressure sensitive adhesive label with the printed layer 2 of this type can carry concealed information on the pressure sensitive adhesive layer 22.

The thickness of the label base 21 is not particularly limited to a specific value, but it is preferable that the thickness is in the range of 20 to 200 μm, and it is more preferable that the thickness is in the range of 25 to 100 μm.

The pressure sensitive adhesive layer 22 of the pressure sensitive adhesive label 20 is constituted of a pressure sensitive adhesive composition which contains a pressure sensitive adhesive as a major component. As for the pressure sensitive adhesive, it is possible to use any of known pressure sensitive pressure sensitive adhesives such as acryl based pressure sensitive adhesives, urethane based pressure sensitive adhesives, epoxy based pressure sensitive adhesives, rubber based pressure sensitive adhesives and silicone based pressure sensitive adhesives and the like.

The thickness of the pressure sensitive adhesive layer 22 is not particularly limited to a specific value, but it is preferable that the thickness is in the range of 1 to 100 μm, and it is more preferable that it is in the range of 10 to 50 μm.

The adhesive strength of the pressure sensitive adhesive layer 22 with respect to an adherend is not particularly limited if it is larger than the adhesive strength between the printed layer 3 and the releasing agent layer 12, and this adhesive strength can be desirously selected depending on purpose of use of the pressure sensitive adhesive label with the printed layer 2.

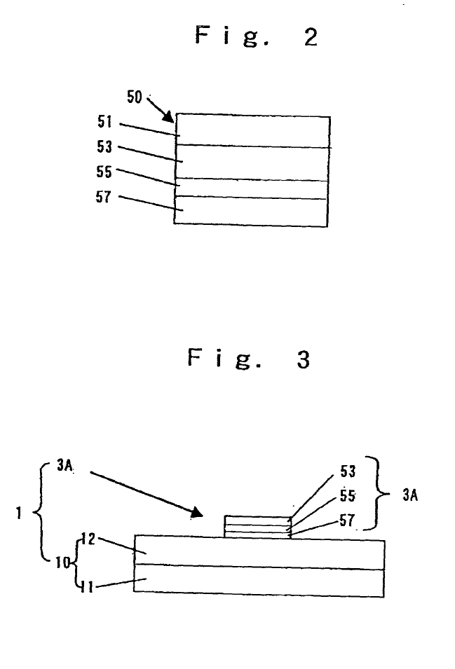

Hereinbelow, a description will be made with regard to a second embodiment of the present invention with reference to FIG. 2. In this second embodiment, a pressure sensitive adhesive layer 22 of a pressure sensitive adhesive label 20 contains fluorescent dye and a printed layer 3A provided on a release sheet 10 includes a metallic layer.

In this embodiment a thermal transfer printing ribbon 50 shown in FIG. 2 is used. In more detail, the thermal transfer printing ribbon 50 is generally constructed from a ribbon base film 51, a colored layer 53 provided on a release surface of the ribbon base film 51, a deposited metallic layer 55 provided on the other surface of the colored layer 53 and an adhesive layer 57 provided on the opposite surface of the deposited metal layer 55. The ribbon base film 51 is preferably formed of a polyethylene terephthalate film or the like. The colored layer 53 is provided for protecting the deposited metal layer 55, and it can be formed of various resins. The deposited metal layer 55 is preferably formed of deposition of aluminum or the like. The adhesive layer 57 is formed of a fatty acid based thermo-melting resin. An example of such a thermal transfer printing ribbon is available from MURATA KIMPAKU CO., LTD. of Japan (product code is MGR Series).

When such thermal transfer printing ribbon 50 is used, a printed layer 3A comprised of the colored layer 53, the deposited metallic layer 55 and the adhesive layer 57 is formed on a release sheet 10 so that the adhesive layer 57 is stuck onto a releasing agent layer 12 of the release sheet 10 as shown in FIG. 3, thereby forming a release sheet with a printed layer 1.

According to this embodiment, when the pressure sensitive adhesive label 2 is peeled off from the release sheet with the printed layer 1, the information provided by the metallic layer 55 of the printed layer 3A is transferred to the pressure sensitive adhesive layer 22 of the pressure sensitive adhesive label 2, thereby obtaining a pressure sensitive adhesive label with a printed layer 2. If such a pressure sensitive adhesive label with the printed layer 2 is attached to an adherend, the fluorescent dye contained in a part of the pressure sensitive adhesive layer 22 excepting the part of the printed information is migrated (transferred) to the adherend. Accordingly, in this modification, even after the pressure sensitive adhesive label 2 has been peeled off, the adherend can be still indicating the information in the form of non-fluorescent portion by irradiation of ultraviolet ray or the like. That is, in the part of the adherend where the pressure sensitive adhesive label with the printed layer 2 was being attached, the transferred fluorescent dye fluoresces by irradiation of ultraviolet ray or the like to indicate the information with the non-fluorescent portion.

As for the fluorescent dye to be contained in the pressure sensitive adhesive layer 22, fluorescent dye, stored light type fluorescent dye and fluorescent brightener can be selectively used.

Hereinbelow, based on FIGS. 1 (a), (b) and (c), a description will be made with regard to a method of manufacturing the pressure sensitive adhesive label with the printed layer of the present invention.

Fist, as shown in FIG. 1(a), a release sheet 10 composed of a release sheet base 11 and a releasing agent layer 12 provided on one surface of the release sheet base 11 is prepared. Then, a printed layer 3 having fixed and/or variable information is formed on the releasing agent layer 12 of the release sheet 10 by means of thermal transfer printing, thereby forming a release sheet with a printed layer 1. As described above, the fixed information may include a frame design, a product name, a company name and the like, and the variable information may include a serial number, a manufacturing number, a manufacturing date and the like. Further, the thermal transfer printing is not limited to a specific way if a thermal transfer type printing apparatus such as a thermal transfer printer and a thermal transfer printing machine is used.

Next, as shown in FIG. 1(b), a pressure sensitive adhesive label 2 having a label base 21 and a pressure sensitive adhesive layer 22 provided on one surface thereof is prepared. The pressure sensitive adhesive label in this state is indicated by the reference numeral 20 in FIG. 1(b). Then, the pressure sensitive adhesive layer 22 of the pressure sensitive adhesive label 2 is stuck onto the releasing agent layer 12 of the release sheet 1 such that the printing layer 3 faces the pressure sensitive adhesive layer 22, thereby forming the pressure sensitive adhesive label with the release sheet having the printed layer 5.

Next, in this state, as shown in FIG. 1(c), when the pressure sensitive adhesive label 20 is removed from the release sheet 10 for using the label, for example, the printed layer 3 formed on the releasing agent layer 12 of the release sheet 10 is transferred to the pressure sensitive adhesive layer 22 of the presser sensitive adhesive label 20 so that the printing layer 3 is peeled off from the releasing agent layer 12. That is, the printing layer 3 is transferred to the pressure sensitive adhesive label 20 from the release sheet 1 to form a pressure sensitive adhesive label with the printed layer 2. The release sheet in this state is indicated by the reference numeral 10 in FIG. 1(c).

In the above manufacturing method, if the pressure sensitive adhesive layer 22 contains fluorescent dye and the printing layer 3 includes a metallic layer 55 as shown in FIG. 2, it is possible to provide an adherend which can indicate the printed information in the form of non-fluorescent part with the transferred fluorescent dye after the pressure sensitive adhesive label with the printed layer 2 has been removed from the adherend. The pressure sensitive adhesive label having such a function is called as “security label” in this specification.

Although the manufacturing method of the present invention has been described with reference to the example show in the drawing, the present invention is not limited thereto. The pressure sensitive adhesive label of the present invention may be manufactured by the following steps. First, a pressure sensitive adhesive label with a release sheet having no printed layer is prepared (in this state, the release sheet is being stuck to the pressure sensitive adhesive label). Then, the pressure sensitive adhesive label is removed from the release sheet, and under this state a printed layer (information layer) is formed on the releasing agent layer of the release sheet by means of thermal transfer printing. Then, the release sheet provided with the printed layer is stuck to the pressure sensitive adhesive layer of the pressure sensitive adhesive label again.

### EXAMPLES

Hereinbelow, actual examples of the present invention will be described.

1. Production of Release Sheet with Printed Layer Using Thermal Transfer Printer

### Example 1

A release sheet with a printed layer was prepared by forming a releasing agent layer having a thickness of 22 μm onto one surface of a release sheet base having a thickness of 93 μm by the extrusion laminating method. Here, the release sheet base used a dust free paper (“Clean Paper” which is a product of Lintec Corporation), and the releasing agent layer used a mixture of 50 wt % of olefin-based thermoplastic elastomer (“TAFMER P-0280G” which is a product of Mitsui Chemicals Inc.) and 50 wt % of polyethylene resin (“HI-αCW2004” which is a product of Sumitomo Chemical Company, Limited). Then, a printed layer having information comprised of letters of “SEALED ON MAY, 2000” was formed on the releasing agent layer by printing using a thermal transfer printer (Product Code “140Xi” produced by Zebra Technologies Corporation) with a thermal transfer ribbon having a transfer layer formed of a thermo-melting resin containing an epoxy resin and a pigment (“AUTONICS HD” which is a product of Autonics Corporation), thereby producing a release sheet with a printed layer (printed information) (which is shown by the reference numeral 1 in FIG. 1(a).

### Example 2

A release sheet with a printed layer was produced in the same manner as that of Example 1 excepting that a thermal transfer ribbon having a transfer layer comprised of a fatty acid ester based resin layer (thermo-melting resin) and a deposition layer of aluminum (“MGR gold” which is a product of Murata Gold Foil Corporation) was used instead of the ribbon of Example 1.

### Example 3

A release sheet with a printed layer was produced in the same manner as that of Example 1 excepting that a release sheet used a glassine paper (thickness: 79 μm) and a polyethylene layer (thickness: 18 μm) laminated on the paper and a releasing agent layer (thickness: 0.7 μm) provided on the polyethylene layer of the release sheet base and constituted of an addition type silicone based releasing agent (“SRX-357” which is a product of Toray Silicone Co., Ltd.) and a thermal transfer ribbon (“MGR gold” which is a product of MURATA KIMPUKU CO., LTD.) was used.

2. Production of Pressure Sensitive Adhesive Label with Printed Layer

### Examples 4 to 6

A pressure sensitive adhesive label (“PA-Tl” which is a product of Lintec Corporation) comprised of a label base made of a transparent polyethylene film having a thickness of 50 μm and a pressure sensitive adhesive layer made of an acryl based resin and having a thickness of 22 μm and provided on the one surface of the label base was prepared, and three of thus formed pressure sensitive adhesive label were stuck onto the release sheets of Examples 1 to 3 described above, respectively, to obtain three pressure sensitive adhesive labels with release sheets having printed layers (which were used as Examples 4 to 6, respectively).

### Examples 7 and 8

A pressure sensitive adhesive label (“PETWH 50 (A) P7006” which is a product of Lintec Corporation) comprised of a label base made of an opaque white polyethylene terephthalate film having a thickness of 50 μm and a pressure sensitive adhesive layer made of an acryl based resin and having a thickness of 24 μm and containing a fluorescent dye and provided on the one surface of the label base was prepared, and two of thus formed pressure sensitive adhesive label were stuck onto the release sheets of Examples 2 and 3 described above, respectively, to obtain two pressure sensitive adhesive labels with release sheets having printed layers (which were used as Examples 7 and 8, respectively).

Next, each of the pressure sensitive adhesive labels with the release sheets of Examples 4 to 8 was subjected to the following manually peeling-off ability test, and then three aspects such as condition of the transferred printed layer, degree of shape keeping of the printed information, and condition of the indicated information with the remaining fluorescent dye were observed and evaluated. The results of the test and observation were shown in the following Table 1.

### Manually Peeling-off Ability Test

When each pressure sensitive adhesive label was peeled off from the release sheet with the printed layer, the operability at that time was evaluated. Here, the degree of the operability was classified as follows.

A: The pressure sensitive adhesive label could be peeled off from the release sheet with the printed layer without any sense of incongruity irrespective of the presence part or absence part of the printed layer.

B: When the pressure sensitive adhesive label was peeled off from the release sheet with the printed layer, it has been encountered with some difficulties at the portion of the presence of the printed layer, and therefore the peeling operation was difficult.

### Condition of the Transferred Printed Layer

After the pressure sensitive adhesive label had been peeled off from the release sheet with the printed layer, the condition of the surface of the releasing agent layer of the release sheet and the condition of the transferred printed layer transferred onto the pressure sensitive adhesive layer of the pressure sensitive adhesive label were observed with the naked eye. The observation results were evaluated in accordance with the following classifications A to D.

A: No printed layer was left on the releasing agent layer, and the printed layer was completely transferred onto the surface of the pressure sensitive adhesive layer.

B: Almost no printed layer was left on the releasing agent layer, and the printed layer was substantially completely transferred onto the surface of the pressure sensitive adhesive layer.

C: A certain degree of the printed layer was left on the releasing agent layer, and the printed layer could not be satisfactorily transferred onto the surface of the pressure sensitive adhesive layer.

D: Most of the printed layer was left on the releasing agent layer, and most of the printed layer was not transferred onto the surface of the pressure sensitive adhesive layer.

### Degree of Shape Keeping of Printed Information

Next, each of the pressure sensitive adhesive labels peeled off from the release sheets with the printed layers was stuck onto the adherend made of a transparent grass plate. Then, the printed information was observed through the label base in each of Examples 4 to 6 each using the transparent label base and through the adherend in each of Examples 7 and 8 each using the opaque label base. The results of the observations of each printed information were evaluated in accordance with the following classifications A to D.

A: No deformation of the indicated information such as deficiency or lack of the printed information was observed at all.

B: Almost no deformation of the indicated information such as deficiency or lack of the printed information was hardly observed.

C. A large deficiency or deformation of the shape was observed in the indicated information.

D: Almost no information was indicated.

### Condition of the Indicated Information with the Remaining Fluorescent Dye

Each of the pressure sensitive adhesive labels peeled off from the release sheets with the printed layers was stuck onto the plate of polypropylene (P.P. Plate) having a thickness of 2 mm. Then, each pressure sensitive adhesive label was pressed five times by reciprocally rolling a rubber roller having a weight of 2 kg. Then, after each label was being left in an atmosphere at a room temperature for 24 hours, each label was peeled off from the P.P. plate and then the plate was irradiated with black light. In this state, the condition of the indicated information by the remaining fluorescent dye which had been transferred to the P.P. plate was observed with the naked eye and the observation results were evaluated in accordance with the following classifications.

A: The printed information comprised of the letters of “SEALED ON MAY, 2000” was easily and clearly recognized.

B: The luminescent part of the P.P. plate fluoresced as a whole so that the information could not be recognized.

TABLE 1

| | | | | Condition of |
|---|---|---|---|---|
| | | Condition of | Degree of | Indicated |
| | Manually | Transferred | Shape Keeping | Information |
| | Peeling-off | Printed | of Printed | With Remaining |
| Ex. No. | Ability Test | Layer | Information | Fluorescent dye |
| Ex. 4 | A | A | A | — |
| Ex. 5 | A | A | A | — |
| Ex. 6 | A | A | A | — |
| Ex. 7 | A | A | A | A |
| Ex. 8 | A | A | A | A |

From the results shown in the Table 1, it has been found that according to the present invention, not only a printed layer of fixed information but also a printed layer of variable information can be easily formed on the releasing agent layer of the release sheet by means of thermal transfer printing using a simple equipment and thus formed printed layer is difficult to come off from the release sheet.

And, according to the present invention, the printed layer can be transferred easily to the pressure sensitive adhesive layer of the pressure sensitive adhesive label by simply sticking the pressure sensitive adhesive label onto the release sheet with the printed layer, there is no possibility that an adhesive is attached to a printing head of a printer which has been caused in the conventional method in which printing was made directly onto the pressure sensitive adhesive layer.

Further, since in the case where the metallic layer is provided in the printed layer of the security label in which the pressure sensitive adhesive layer contains fluorescent dye, it is possible to provide an adherend which can indicate the printed information in the form of fluorescent part with the transferred fluorescent dye after the pressure sensitive adhesive label with the printed layer has been peeled off from the adherend. As a result, the fact that the pressure sensitive adhesive label had been being attached to the adherend is learned from the adherend.

Finally, it is to be understood that the present invention is not limited to Examples described above, and many changes or additions may be made without departing from the scope of the invention which is determined by the following claims.

What is claimed is:

1. A release sheet with a printed layer for use with a pressure sensitive adhesive label for indicating information, comprising:
a release sheet base;
a releasing agent layer provided on one of the surfaces of the release sheet base; and
a printed layer provided on the releasing agent layer, said printed layer having fixed and/or variable information and being formed by means of thermal transfer printing.

2. A pressure sensitive adhesive label for indicating information, the pressure sensitive adhesive label being adapted to be stuck onto a release sheet with a printed layer before the pressure sensitive adhesive label is used, which comprises:
a label base;
a pressure sensitive adhesive layer provided on one of the surfaces of the label base; and
a printed layer provided on the pressure sensitive adhesive layer, said printed layer having fixed and/or variable information, wherein the release sheet according to claim 1 is stuck onto the pressure sensitive adhesive layer through the releasing agent layer so that the printing layer faces the pressure sensitive adhesive layer.

3. The pressure sensitive adhesive label as claimed in claim 2, wherein the pressure sensitive adhesive layer contains fluorescent dye and the printed layer includes a metallic layer.

4. A method of manufacturing a pressure sensitive adhesive label with a printed layer for indicating information, comprising the steps of:
preparing a release sheet having a release sheet base and a releasing agent layer provided on one surface of the release sheet base, and then forming a printed layer having fixed and/or variable information on the releasing agent layer by means of thermal transfer printing, thereby forming a release sheet with a printed layer;
preparing a pressure sensitive adhesive label having a label base and a pressure sensitive adhesive layer provided on one surface of the label base;
sticking the pressure sensitive adhesive layer of the pressure sensitive adhesive label onto the releasing agent layer of the release sheet such that the printed layer faces the pressure sensitive adhesive layer; and
transferring the pressure sensitive adhesive layer from the printed layer on the release agent layer.

5. The method as claimed in claim 4, wherein the pressure sensitive adhesive layer contains fluorescent dye and the printed layer includes a metallic layer.
